(19) United States
(12) Patent Application Publication
(10) Pub. No.: US 2018/0156760 A1
(43) Pub. Date: Jun. 7, 2018

(54) INDUCTIVE FLASH DESORBER

(71) Applicant: Government of the United States of America, as represented by the Secretary of Commerce, Gaithersburg, MD (US)

(72) Inventors: Thomas J. Bruno, Broomfield, CO (US); Kimberly N. Urness, Louisville, CO (US)

(21) Appl. No.: 15/786,145

(22) Filed: Oct. 17, 2017

Related U.S. Application Data
(60) Provisional application No. 62/430,131, filed on Dec. 5, 2016.

(51) Int. Cl. G01N 30/06; G01N 1/22; G01N 1/40; G01N 35/10; H01F 27/28; H01F 27/24

(52) U.S. Cl. CPC G01N 30/06; G01N 1/2214; H01F 27/24; G01N 35/1097; H01F 27/2804; G01N 1/405

(57) ABSTRACT

An inductive flash desorber includes: an induction coil that includes a coil; an substrate disposed through the induction coil; and a flow tube interposed between the induction coil and the substrate such that the flow tube: is encircled by the coil; surrounds the substrate within the coil; receives a carrier fluid that entrains the desorbed analyte from the substrate; and forms an analytical composition comprising the carrier fluid and the desorbed analyte, the flow tube including: a first end that receives the carrier fluid; and a second end opposing the first end through which the analytical composition flows.

### CROSS REFERENCE TO RELATED APPLICATIONS

This application claims the benefit of U.S. Provisional Patent Application Ser. No. 62/430,131, filed Dec. 5, 2016, the disclosure of which is incorporated herein by reference in its entirety.

### STATEMENT REGARDING FEDERALLY SPONSORED RESEARCH

This invention was made with United States Government support from the National Institute of Standards and Technology (NIST), an agency of the United States Department of Commerce. The Government has certain rights in the invention. \Licensing inquiries may be directed to the Technology Partnerships Office, NIST, Gaithersburg, Md., 20899; voice (301) 301-975-2573; email tpo@nist.gov; reference NIST Docket Number 16-035US1.

### BRIEF DESCRIPTION

Disclosed is an inductive flash desorber comprising: an induction coil that produces a magnetic field in response to flowing an electrical current through the induction coil, the induction coil comprising an electrical conductor that is wound into a coil; an substrate disposed through a central portion of the induction coil, the substrate comprising an electrical conductor and that: adsorbs a surface-active species; produces an eddy current in presence of the magnetic field; heats in response to producing the eddy current; and desorbs the surface-active species in response to being heated to form desorbed analyte from the surface-active species; and a flow tube interposed between the induction coil and the substrate such that the flow tube: is encircled by the coil; surrounds the substrate within the coil; receives a carrier fluid that entrains the desorbed analyte from the substrate; and forms an analytical composition comprising the carrier fluid and the desorbed analyte, the flow tube comprising: a first end that receives the carrier fluid; and a second end opposing the first end through which the analytical composition flows.

A process for performing inductive desorption, the process comprising: adsorbing a surface-active species on an substrate of an inductive flash desorber that comprises: an induction coil comprising an electrical conductor that is wound into a coil; an substrate disposed through a central portion of the induction coil and comprising an electrical conductor; and a flow tube interposed between the induction coil and the substrate such that the flow tube is encircled by the coil and surrounds the substrate within the induction coil, the flow tube comprising: a first end; and a second end opposing the first end; flowing an electrical current through the induction coil; producing, by the induction coil, a magnetic field in response to flowing the electrical current; producing, by the substrate, an eddy current in presence of the magnetic field; heating the substrate in response to producing the eddy current; desorbing the surface-active species from the substrate in response to being heated to form a desorbed analyte from the surface-active species; flowing a carrier fluid through the flow tube from the first end towards the second end; entraining the desorbed analyte in the carrier fluid in the flow tube to form an analytical composition comprising the carrier fluid and the desorbed analyte; and flowing the analytical composition toward the second end and away from the first end to perform inductive desorption.

### BRIEF DESCRIPTION OF THE DRAWINGS

The following descriptions should not be considered limiting in any way. With reference to the accompanying drawings, like elements are numbered alike.

FIG. 1 shows an inductive flash desorber;

FIG. 2 shows a top view of the inductive flash desorber shown in FIG. 1;

FIG. 3 shows a cross-section of the inductive flash desorber shown in FIG. 1 through line A-A shown in FIG. 2;

FIG. 4 shows an inductive flash desorber;

FIG. 5 shows an inductive flash desorber;

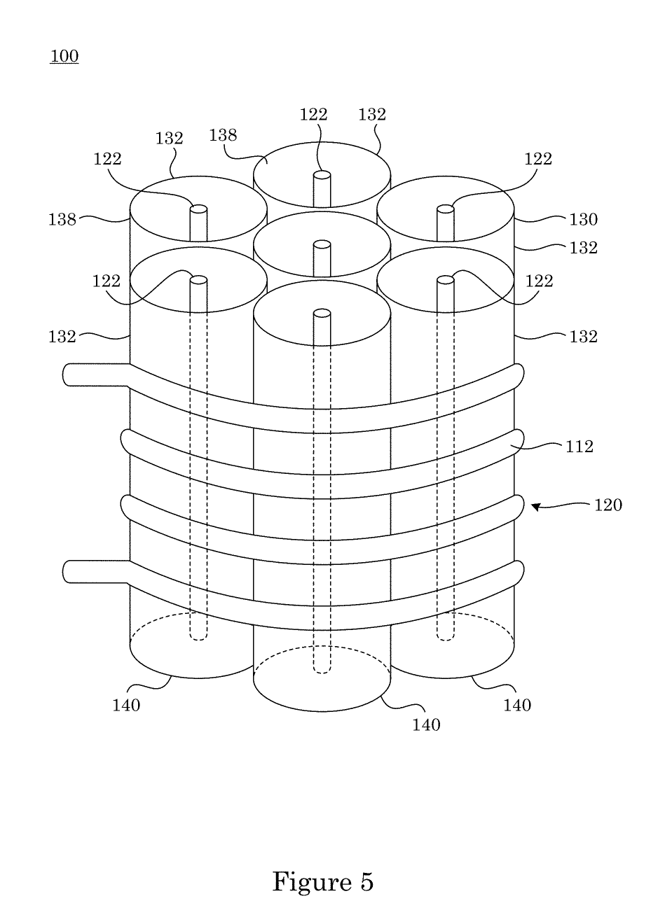

FIG. 6 shows an anlaytical substrate of an inductive flash desorber with adsorbed surface-active species in panels A and B and desorbed analyte in panel C;

FIG. 7 shows an anlaytical substrate with adsorbed surface-active species in panel B;

FIG. 8 shows an inductive flash desorber;

FIG. 9 shows an inductive flash desorber;

FIG. 10 shows components of an inductive flash desorber;

FIG. 11 shows components of an inductive flash desorber;

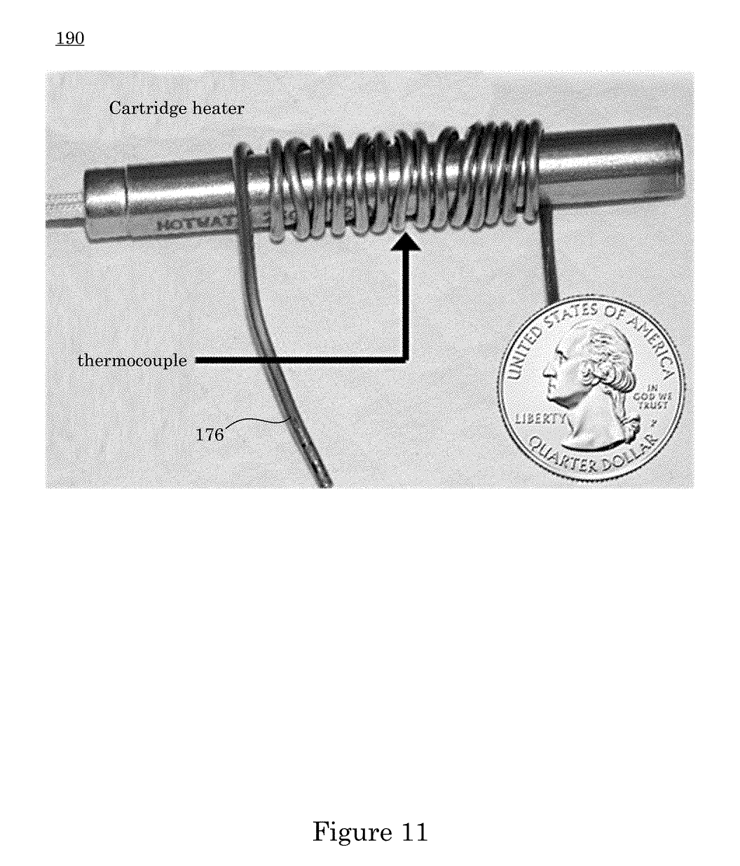

FIG. 12 shows a graph of temperature versus heating time;

FIG. 13 shows a graph of total component abundance versus retention time;

FIG. 14 shows a graph of total component abundance versus retention time;

FIG. 15 shows a graph of total component abundance versus retention time;

FIG. 16 shows a graph of temperature versus heating time; and

FIG. 17 shows a graph of total ion abundance versus retention time.

### DETAILED DESCRIPTION

A detailed description of one or more embodiments is presented herein by way of exemplification and not limitation.

Advantageously and unexpectedly, it has been discovered that an inductive flash desorber provides fast, solvent-free extraction of surface-active species by inductive flash desorption and characterizes the surface-active species. The inductive flash desorber includes a substrate. The substrate can be immersed in or exposed to a fluid or a solid that contains surface-active species. In response to an eddy current formed through induction, the substrate thermally releases or desorbs a desorbed analyte from adsorbed surface-active species from the surface of the substrate. The substrate heats rapidly by induction heating. The desorbed analyte is communicated to a chemical analyzer. The desorbed analyte is detected by a selected analytic technique such as gas chromatography with mass spectrometry. Beneficially, the apparatus and process herein can be used as a test protocol as well as a research tool with applicability in chemical analysis including tribology, medical implant studies, bacterial corrosion work (e.g., microbial induced corrosion), forensics, and the like.

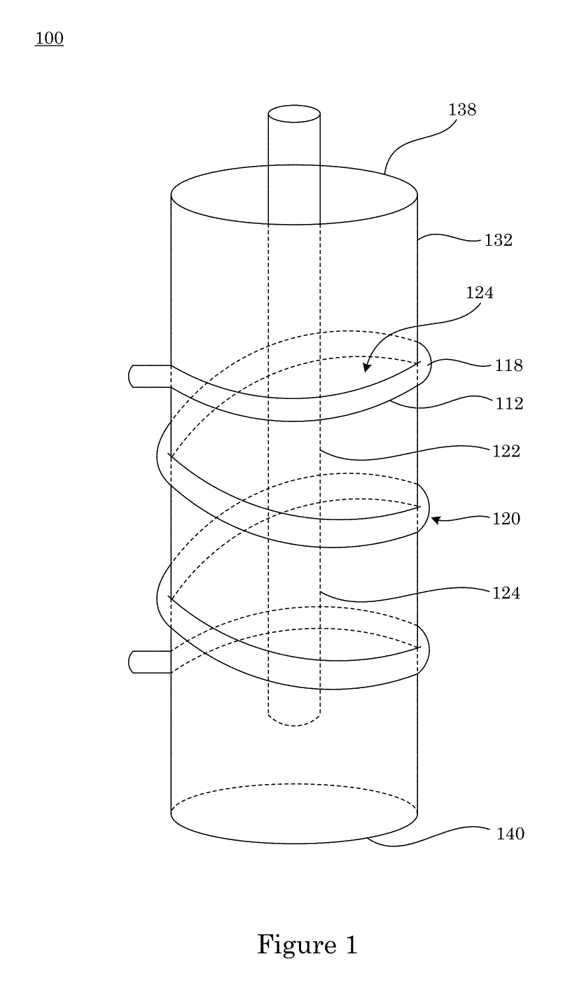

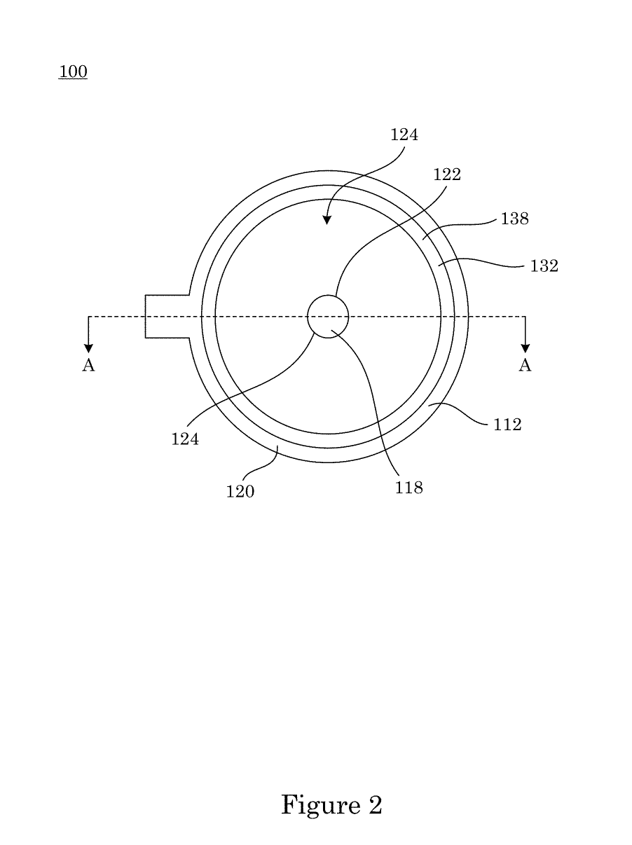

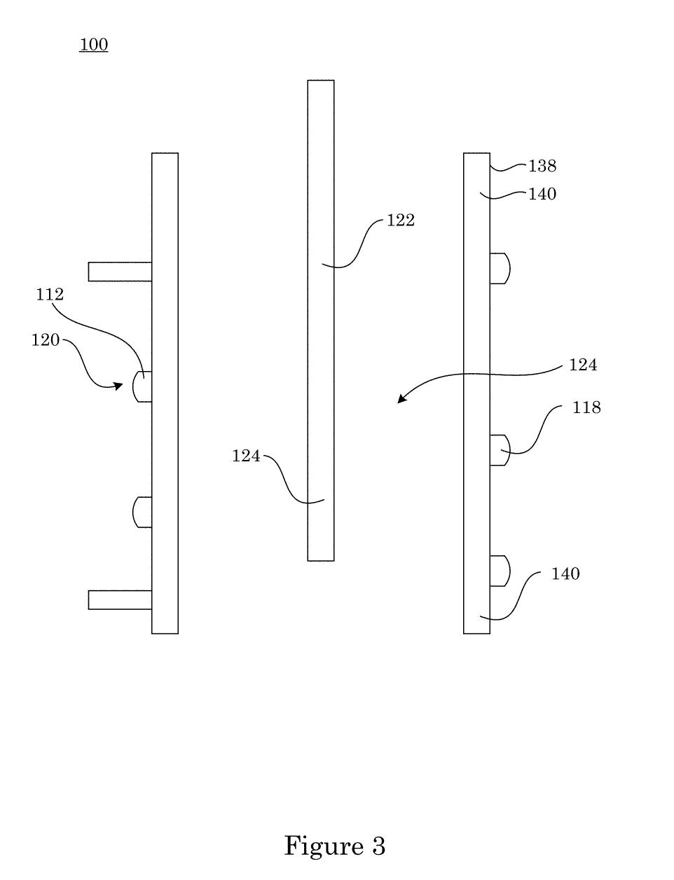

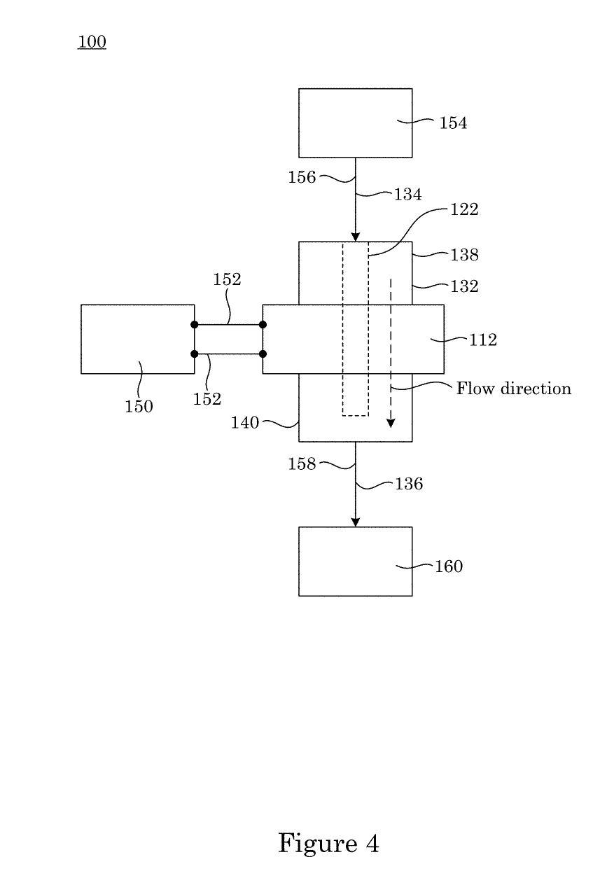

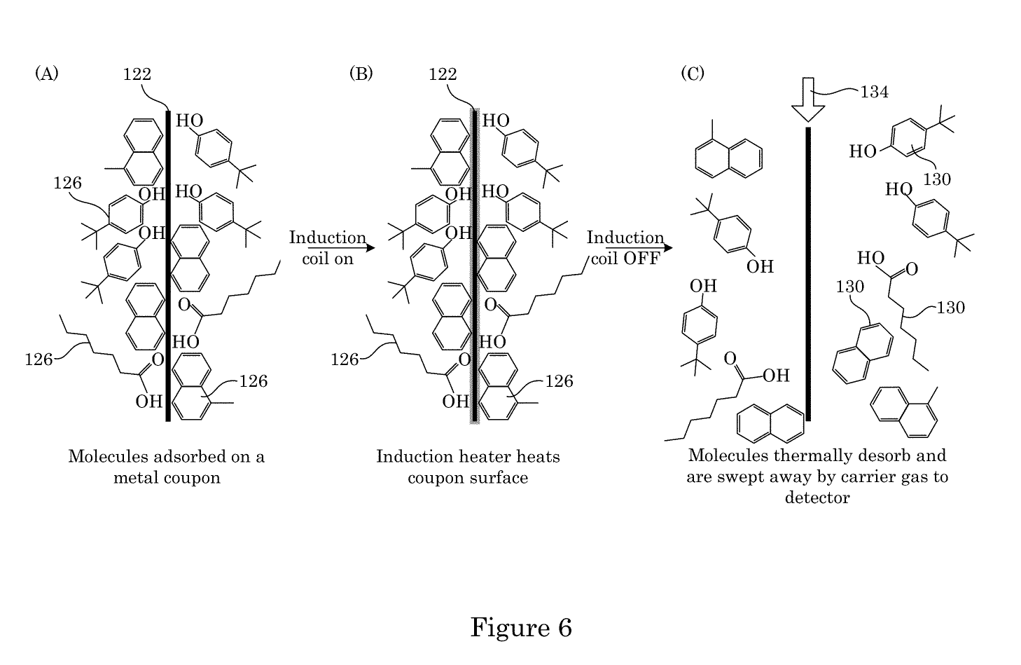

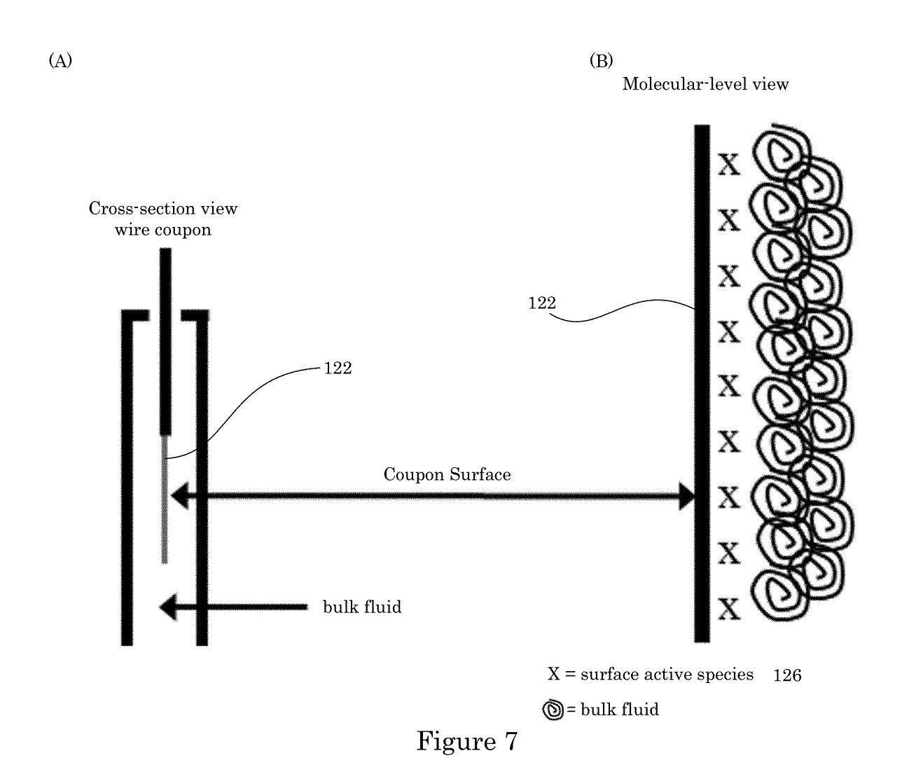

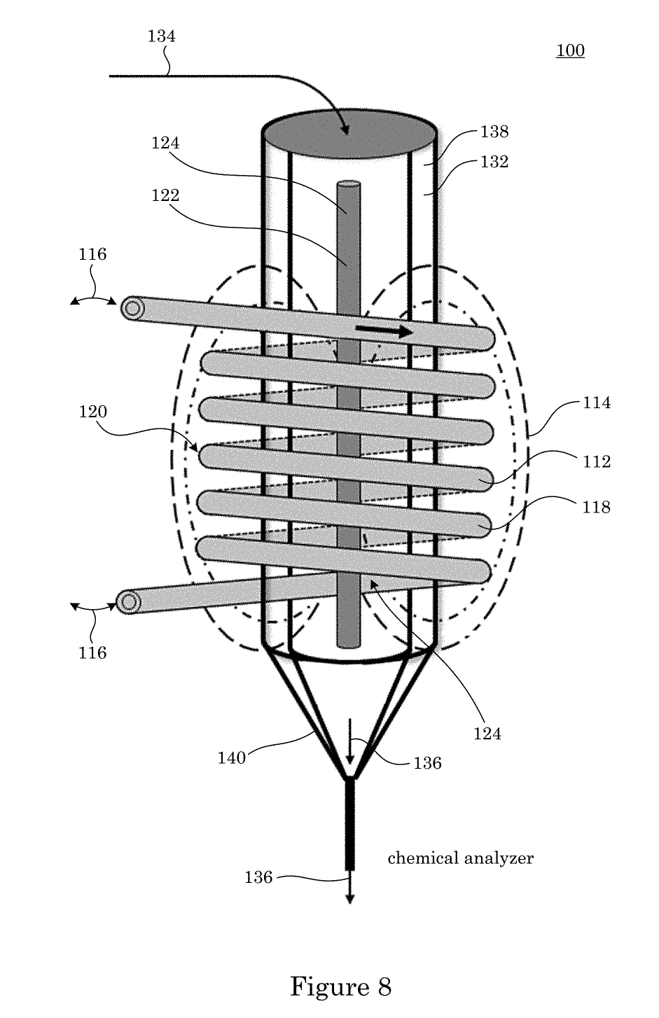

In an embodiment, with reference to FIG. 1, FIG. 2, FIG. 3, FIG. 4, FIG. 6, FIG. 7, and FIG. 8 inductive flash desorber 100 includes: induction coil 112 that produces magnetic field 114 in response to flowing electrical current 116 through induction coil 112, induction coil 112 including electrical conductor 118 that is wound into coil 120; substrate 122 disposed through central portion 124 of induction coil 112, substrate 122 including electrical conductor 124 and that: adsorbs surface-active species 126; produces eddy current 128 in presence of magnetic field 114; heats in response to producing eddy current 128; and desorbs surface-active species 126 in response to being heated to form desorbed analyte 130 from surface-active species 126; and flow tube 132 interposed between induction coil 112 and substrate 122 such that flow tube 132: is encircled by coil 120; surrounds substrate 122 within coil 120; receives carrier fluid 134 that entrains desorbed analyte 130 from substrate 122; and forms analytical composition 136 including carrier fluid 134 and desorbed analyte 130. Here, flow tube 132 includes: first end 138 that receives carrier fluid 134; and second end 140 opposing first end 138 and through which analytical composition 136 flows.

In an embodiment, with reference to FIG. 4, inductive flash desorber 100 includes power member 150 in electrical communication with induction coil 112 via wire 152. Power member 150 provides electrical current 116 through wire 152 to induction coil 112. Fluid source 154 can be in fluid communication with flow tube 132 via entry conduit 156 to provides carrier fluid 134 to flow tube 132. In flow tube 132, carrier fluid 134 and analytical composition 136 flow away from first end 138 and towards second end 140. Further, chemical analyzer 160 is in fluid communication with flow tube 132 at second end 140 via exit conduit 158 through which analytical composition 136 is communicated from flow tube 132 to chemical analyzer 160.

Induction flash desorber 100 includes induction coil 112 to inductively heat substrate 122. It is contemplated that induction coil 122 can include any material that provides for electrical conductivity and electric current therethrough. Exemplary materials for induction coil 112 include metals such as copper, silver, and the like, or a combination thereof. An amount of electrical current through induction coil 112 can be selected to be an amount that produces magnetic field 114 having a selected magnetic field strength to inductive heat substrate 122 to a selected temperature. A number of turns in coil 120 can be selected based on desired magnetic field strength. A length and diameter of coil 120 can be selected based on material physical and chemical properties of the test substrate to be heated.

Substrate 122 is inductively heated in a presence of magnetic field 114 provided by induction coil 112. To this end, induction coil 122 can include any material that provides for electrical conductivity and production of eddy currents at a surface of substrate 122. Exemplary materials for substrate 122 include a metal (e.g., iron and the like, or a combination thereof), steel, nickel alloy, and the like, or a combination thereof. It is contemplated that substrate 122 can include a core that is coated with an electrically conductive material that produces eddy currents in presence of magnetic field 114. The core can run a length of substrate 122 in coil 120. The core can be, e.g., a metal (e.g., iron and the like, or a combination thereof), steel, nickel alloy, and the like, or a combination thereof. The coating disposed on the core can be, e.g., a metal (e.g., copper and the like or a combination thereof), ceramic, metallic oxide, silica, and the like, or a combination thereof.

A size or shape of substrate 122 can be selected based on a selected application of induction flash desorber 100. Exemplary substrates 122 include a wire, coupon, rod, and the like. In an embodiment, substrate 122 is a wire that extends along a length of flow tube 132. It is contemplated that inductive flash desorber 100 can include a plurality of substrates 122 that are spaced apart inside flow tube 132. Here, the number of substrates can be as few or as many as desired to adsorb surface-active species 126 or to provide a number density of desorbed analytes 130 in analytical composition 136.

The temperature to which substrate 122 is heated can be selected based on a desorption temperature of these desorbed analyte 130. This temperature can be, e.g., from just above room temperature (for a non-magnetic material) to greater than 700° C. (glowing) for ferromagnetic materials. The temperature can be much less and the range can depend on the substrate, the available power supply, and the desired application. A heating rate of substrate 122 can be tens of degrees Celsius per second at low magnetic fields to hundreds of degrees Celsius per second at much larger magnetic fields; the resonant frequency and current output of the available power supply will determine the rate.

Flow tube 132 is interposed between induction coil 112 and substrate 122 and transmits magnetic field 114. Flow to 132 can include any material that provides for transmission of magnetic field 114 and fluid communication of carrier fluid 134 and analytical composition 136. Exemplary materials for flow to 132 include a glass, polymer, ceramic, non-magnetic metal.

A size or shape of flow tube 132 can be selected based on a selected application. A volume of flow tube 132 can be, e.g., from one cubic millimeter to hundreds of cubic meters, specifically from tens of cubic millimeters to hundreds of cubic centimeters. The size and shape of flow tube 132 allows carrier fluid 134 to flow through flow tube 132 in essentially laminar flow.

Exemplary flow tubes 132 include a syringe barrel, pipette, and the like. In an embodiment, flow tube 132 is a syringe barrel having a length in which substrate 122 is disposed. It is contemplated that inductive flash desorber 100 can include a plurality of substrates arranged in a selected configuration and disposed in flow tube 132 that is disposed in coil 120 of induction coil 112. Here, the number of substrates can be as few or as many as desired.

The temperature to which substrate 122 is heated can be selected based on a desorption temperature of desorbed analyte 130. This temperature can be, e.g., just above room temperature (for a non-magnetic material) to greater than 700° C. (glowing) for ferromagnetic materials. The desired temperature may be much less and the range will depend on the substrate, the available power supply, and the desired application.

Power member 150 provides electrical current 116 to induction coil 112. Power member 150 can include various components to provide electrical current 116 as direct current (DC) or alternating current (AC). In an embodiment, power member 150 includes connection to the mains, a means of controlling voltage and current, appropriate combination of inductance and capacitance to achieve desired resonant frequency, measurement of voltage and current, and all appropriate safety features such as circuit interrupts. An average amperage of electrical current 116 can be specifically from less than 1 A to 10 s of amps or more, depending upon the desired application. A frequency of electrical current 116 can be from 10 kHz or less to more than hundreds of kHz, depending upon the substrate.

Fluid source 154 provides carrier fluid 134 to flow tube 132. Exemplary fluid source 154 includes gas cylinders, gas generators, pumps, pressure regulating valves, needle valves, mass flow controllers and the like. In an embodiment, fluid source 154 includes a pressure regulating valve. A pressure of carrier fluid 134 from fluid source 154 is arbitrary.

Carrier fluid 134 entrains desorbed analyte 130 from the surface of substrate 122. Exemplary carrier fluids 134 include nitrogen, carbon dioxide, helium, argon, sulfur hexafluoride, air, and the like, or a combination thereof. It is contemplated that carrier fluid 134 does not react with desorbed analyte 130 or surface-active species 126. In an embodiment, carrier fluid 134 includes helium or carbon dioxide.

Surface-active species 126 adsorbs on substrate 122. Exemplary surface-active species 126 include lubricants, biological fluids, fuels and additives, corrosion inhibitors, anti-wear additives, and the like, or a combination thereof. It is contemplated that surface-active species 126 does not react with substrate 122. In some embodiments, surface-active species 126 reacts with substrate 122. Surface-active species 126 can be present in an amount from 1 part per trillion to 100 parts per thousand.

Substrate 122 is inductively heated in presence of magnetic field 114 from induction coil 112. In this manner, surface-active species 126 desorbs from substrate 122 as desorbed analyte 130. Desorbed analyte 130 can be the same as surface-active species 126. According to an embodiment, desorbed analyte 130 can be different than surface-active species 126. In an embodiment, desorbed analyte 130 can include a plurality of different species in which none, some, or all of the different species are identical to surface-active species 126.

In an embodiment, a process for making inductive flash desorber 100 includes disposing the inlet of a syringe flow tube on a fitting (e.g., an O-ring compression fitting); attaching a needle with a valve to the outlet of the flow tube; inserting the needle into the analytical device with the valve closed; and disposing the syringe in the coil, wherein the coil is located proximate to the analytical device so that a small volume is included between the syringe and analytical device.

In an embodiment, a process for making inductive flash desorber 100 includes attaching power member 150 to induction coil 112 with wires 152; connecting fluid source 154 to entry conduit 156 that contains carrier fluid 134 to first end 138 of syringe barrel 132; surrounding the syringe barrel 132 with coil 112 such that syringe barrel 132 contains the substrate and surface-active species 122; and connecting second end 140 to exit conduit 158; and connecting second end 140 to chemical analyzer 160, wherein analytical composition 136 is communicated through the exit conduit 158 prior to entering the chemical analyzer 160.

According to an embodiment, a process for performing inductive desorption includes: adsorbing surface-active species 126 on substrate 122 of inductive flash desorber 100; flowing electrical current 116 through induction coil 112; producing, by induction coil 112, magnetic field 114 in response to flowing electrical current 116; producing, by substrate 122, an eddy current in presence of magnetic field 114; heating substrate 122 in response to producing the eddy current; desorbing surface-active species 126 from substrate 122 in response to being heated to form desorbed analyte 130 from surface-active species 126; flowing carrier fluid 134 through flow tube 132 from first end 138 towards second end 140; entraining desorbed analyte 130 in carrier fluid 134 in flow tube 132 to form analytical composition 136 including carrier fluid 134 and desorbed analyte 130; and flowing analytical composition 136 toward second end 140 and away from first end 138 to perform inductive desorption. The process further can include communicating analytical composition 136 to chemical analyzer 160 from second end 140; and determining a chemical identity of desorbed analyte 130. Based on the chemical identity of desorbed analyte 130, the chemical identity of surface-active species 126 can be determined. Here, desorbing surface-active species 126 from substrate 122 occurs in an absence of a liquid solvent in flow tube 132.

In a certain embodiment, heating substrate 122 consists essentially of inductive heating in an absence of contact heating, also referred to as non-contact heating. That is, heating that is achieved without the attachment of electrical connection for resistance heating, and without the contact of a heat exchanger such as a cartridge heater, strip heater, ribbon heater, or separate resistance element.

It is contemplated that in the process for performing inductive desorption, adsorbing surface-active species 126 on substrate 122 of inductive flash desorber 100 includes exposing the surface to the fluid of interest at atmospheric conditions (room temperature, atmospheric pressure), or could involve heating the test substrate and fluid together at a defined elevated pressure. Following exposure of test substrate to fluid, the substrate is gently dried to remove any excess bulk fluid from the surface and then placed into the flow tube for inductive desorption.

Flowing carrier fluid 134 through flow tube 132 from first end 138 towards second end 140 includes setting appropriate flow rate of chosen carrier fluid.

Flowing electrical current 116 through induction coil 112 includes energizing power member 150 and verifying operation.

Producing, by induction coil 112 magnetic field 114 in response to flowing electrical current 116, an eddy current in substrate 122 includes verifying necessary conditions are reached to achieve heating in the material of interest.

Heating substrate 122 in response to producing the eddy current to desorb surface-active species 126 from substrate 122 to form desorbed analyte 130 includes maintaining power member in energized state for a sufficient length of time to heat substrate to desired temperature.

Entraining desorbed analyte 130 in carrier fluid 134 in flow tube 132 to form analytical composition 136 including carrier fluid 134 and desorbed analyte 130 includes maintaining flow through tube at a flow rate sufficient to transfer desorbed analyte 130 away from substrate.

Flowing analytical composition 136 toward second end 140 and away from first end 138 includes maintaining flow through tube for a sufficient length of time.

Moreover, communicating analytical composition 136 to chemical analyzer 160 from second end 140 includes continuing to flow carrier fluid until desorbed analyte 130 in carrier fluid 134 has been transferred.

Determining a chemical identity of desorbed analyte 130 includes selected qualitative analysis protocols, such as mass spectral analysis, flame ionization detection, infrared gas cell, atomic emission, and the like.

Additionally, determining the chemical identity of surface-active species 126 based on the chemical identity of desorbed analyte 130 includes using selected analytical tools and experience base, such as mass spectral fragmentation patterns, mass spectral libraries, wavelength(s) of infrared absorbance, chromatographic retention times, atomic emission cross sections, and the like.

The articles and processes herein are illustrated further by the following Example, which is non-limiting.

### Example

Chemical species that adhere on a surface of a substrate may be called surface active species (SAS). In this Example, we describe evaluation of surface-active species. Here, evaluation includes identifying qualitatively what is present and quantitating species that are present. Substrates can include, without limitation, a metal surface lubricated by an oil, a medical implant bathed in biological fluids, a solid phase passive sampling device, tank or pipe surface subjected to microbial induced corrosion, a forensic artifact, and the like.

In a well-characterized situation, one might be able to use a solvent to remove the adhered SAS after determining that the solvent will leave nothing of interest behind, and the solvent must not contribute to the analytical burden. A nearly instantaneous release of the SAS from the surface is desired, without solvent, followed by an immediate transport of the SAS to an analytical device for characterization.

Induction heating of the underlying substrate in SAS characterizations is fast and nearly instantaneous. The heating can be restricted to the surface region of the substrate instead of the bulk. Induction heating can be applied to large and small substrates to substrates of different geometries while the substrate is disposed in a holder or chamber, separate and remote from a heating member. Additionally, an inductive flash desorber with these attributes can be field portable.

Induction heating can be applied to an electrically conductive substrate, e.g., a ferromagnetic material. It is contemplated that the surface of the substrate can be functionalized to provide the desired surface characteristics for inductive heating.

The inductive flash desorber described in this Example is a fast, solvent-free apparatus for extraction by inductive flash desorption to characterize the SAS. The inductive flash desorber takes a sample immersed in (or exposed to) a fluid or a solid that contains SAS and thermally releases or desorbs the interacting species from the surface extremely rapidly with induction heating, followed by immediate transfer into an analytical device. This is depicted in FIG. 6, which shows a lubricant on a surface. The desorbed analytes are detected by a selected analytic technique such as gas chromatography with mass spectrometry.

Inductive Flash Desorption: Lubricants and Lubricity.

Liquid fuels aboard modern high-performance aircraft currently fulfill the role of not only the propellant but also a heat transfer fluid and a hydraulic fluid. The fuels themselves have now reached their thermal capacity for effective cooling, and any additional heat load results in unfavorable thermal stress to the fuel, restricting further performance gains. A proposed method to improve the operability of these aircraft and increase efficiency is to eliminate the entire lubricant system and require that the fuel serve not only as the propellant and coolant, but also as the lubricant. This transition includes identification of characteristics of fuel lubricity to design fuel blends to optimize this function.

Fuel pump failures in jet aircraft due to severe hydrotreatment processes to remove sulfur from the fuel spawned research to determine the classes of molecules that enhance or reduce the fuel's lubricity. Classes of molecules that improve lubricity include alkyl polar compounds (e.g., fatty acids), phenols, nitrogen-containing species, and aromatic hydrocarbons. Molecules attributed with lubricity are surface active, and form a thin, protective film on the surface. Such molecules are present in trace amounts (<0.1%, based on mass) and are difficult to detect and identify.

A good lubricant is surface active as shown in FIG. 7. We identify in a liquid sample species that interact with various surfaces to provide lubricity. Here, we immerse a substrate, e.g., a wire coupon, of suitable material in a mixture that may or may not contain surface-active species. The coupon can be a metal that is a mechanical system that wears less with lubrication. After a period of immersion at a selected temperature and pressure, the substrate is removed from the mixture. Surface-active species with an affinity for the surface of the substrate remain on the substrate. Evaluating the lubricant includes nearly instantaneous release or ejection of the surface-active species from the coupon without the use of a solvent, which can contaminate the substrate. To achieve this extremely rapid and provide clean release of the surface-active species as the desorbed analyte, the inductive flash desorber includes heating coupled with sample recovery and analysis metrology.

Heating by induction involves a high-frequency resonant circuit. The high-frequency alternating current through the induction coil produces a high-frequency alternating magnetic field within the vicinity of the coil as shown in FIG. 8. When an electrically conducting material of the substrate is disposed within the coil, the magnetic field induces a current in the substrate that heats primarily the surface of the substrate.

By use of induction to heat the substrate (i.e., coupon in this Example), the adsorbed surface-active species are removed very rapidly and without a solvent, with desorbed species referred to as desorbed analyte. In the case of a mixture that contains unknown adsorbents as the surface-active species, if a solvent is used to remove the surface-active species from the substrate, the choice of solvent would be ambiguous. If there are surface-active species that are insoluble in the selected solvent, such insoluble surface-active species would not be desorbed and detected. In addition, the solvent could interfere with the detection, e.g., as in this case of gas chromatography. The inductive flash desorber provide rapid, non-contact heating and keep the surface-active species free of possible contaminants while the surface-active species is maintained in an inert environment.

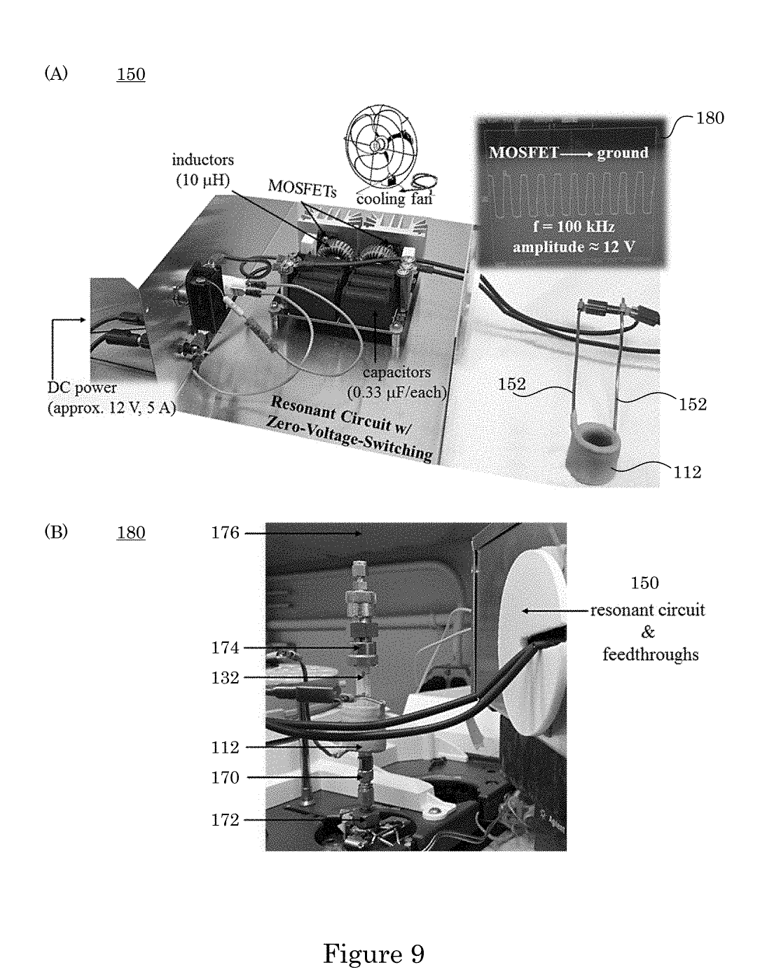

A power member for induction heating includes a high-frequency power supply, and some components of the power member are shown in FIG. 9a. The MOSFETs amplify a 12 V, 5 A input signal from a DC power supply and produce a voltage on the coil greater than 100 V. The resonant frequency of power member is approximately 100 kHz, which is sufficient to heat a range of electrical conductors, including relatively poor conductors such as those with a high electrical resistivity, e.g., room temperature steel. A resonant frequency for better electrical conductors (e.g., copper) is greater for the same diameter of the substrate. The resonant circuit of the power member can be modified for certain surfaces of the substrate. The coil shown in FIG. 9 includes a 1.8 mm copper tubing that is about 2 cm in diameter and 3 cm in length with about 10 turns of the tubing. The coil was coated with a thermally conductive ceramic to protect and provide stability to the coil, and the ceramic does not interfere with the magnetic field.

With regard to recovery and transfer of the desorbed analyte formed from desorption of the surface-active species from the substrate, we positioned inside of the induction coil a borosilicate glass chamber as a flow tube. Here, the flow tube is a modified gas-tight syringe although other flow tubes can be used. The substrate is disposed in the inside of the syringe flow tube.

A gas source provides carrier fluid as a sweep or carrier gas to the inlet of the syringe flow tube through a pressure tight fitting disposed on a first end (entry) of the syringe. The flow of gas is selected to be inert to the surface-active species on the coupon and is communicated to the coupon. At a second end of the syringe disposed opposite to that of first end that has the pressure tight fitting, a needle with an appropriate gauge is affixed. The needle delivers the desorbed analyte from the coupon to an analytical device, e.g., a chemical analyzer.

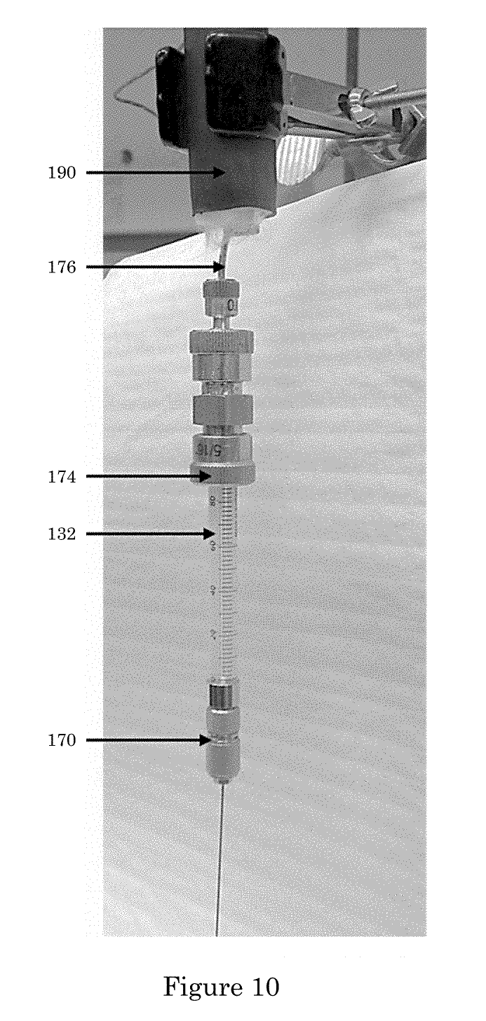

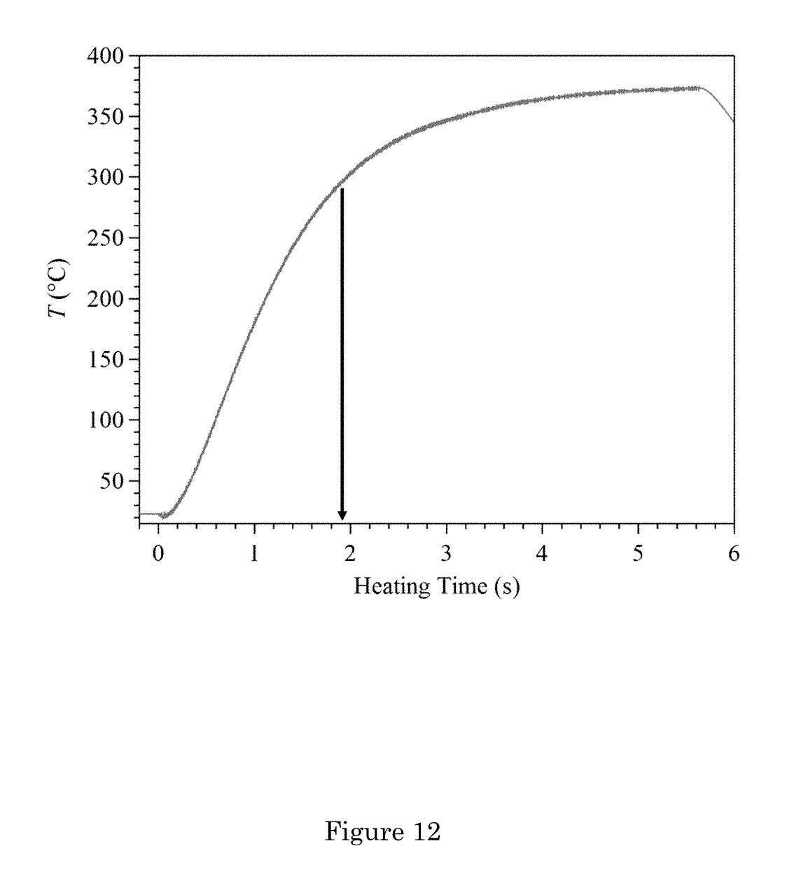

FIG. 9b and FIG. 10 show injection sampling with inductive flash desorber 100 that included syringe 132 as the flow tube inserted into the coil of inductive coil 112. The coupon was disposed in syringe 132. As shown in FIG. 9b, O-ring fitting 174 was disposed at the first end of syringe 132, and on-off valve 170 was disposed at the second end of syringe 132. The analytical composition was communicated through injection port 172 of a gas chromatograph in communication with a mass spectrometer. Fused silica capillary 176 was connected to O-ring fitting 174 and delivered the carrier gas into syringe 132. Wires 152 connected induction coil 112 to power member 150. Power member 150 is shown in FIG. 9a and included inductors, MOSFETs, a cooling fan, capacitors, and DC power that formed the resonant circuit with zero voltage switching and provided the electrical current to induction coil 112 as represented by waveform 180 as an inset in FIG. 9a. FIG. 10 shows inductive flash desorber 100 with induction coil 112 removed from syringe 132. An induction heating profile for a temperature of the coupon disposed in syringe 132 is shown in FIG. 12. Here, the coupon that serves as the substrate is heated to 300° C. in less than two seconds and provides a rapid response time for thermally desorbing surface-active species absorbed on the coupon into desorbed analyte.

During testing, the coupon was a 302 stainless steel (magnetic) wire that had a 0.5 mm diameter and 30 mm length. The coupon was immersed in diluted liquid solutions (0.05 to 10 wt. % in n-hexane, n-decane or n-dodecane) of a jet fuel (JP-8), a diesel fuel surrogate (9 components), JP-8 with a high-temperature additive, a fully qualified lubricant for aviation turbine engines (polyol esters with tricresyl phosphate for surface passivation), and various species previously found to reduce the wear scar diameter in mechanical tests (such as 8-hydroxyquinoline in dodecane). Immersion times of the coupon in the liquid ranged from 10 minutes (min) to 2 hours (hr) at either room temperature or 250° C. and approximately 3000 psi. After removal from the liquid, the coupon was dried with compressed air to remove residual solvent and was sealed inside the gas-tight syringe. A flow of carrier gas that was either helium or carbon dioxide (for improved collisional efficiency/affinity to sweep the species away from the heated coupon) was communicated through the syringe containing the coupon. The flow began 5 s prior to inductively heating the substrate and continued for 30 s after heating. In order to heat the coupon, the induction heater was pulsed on for up to 5 s.

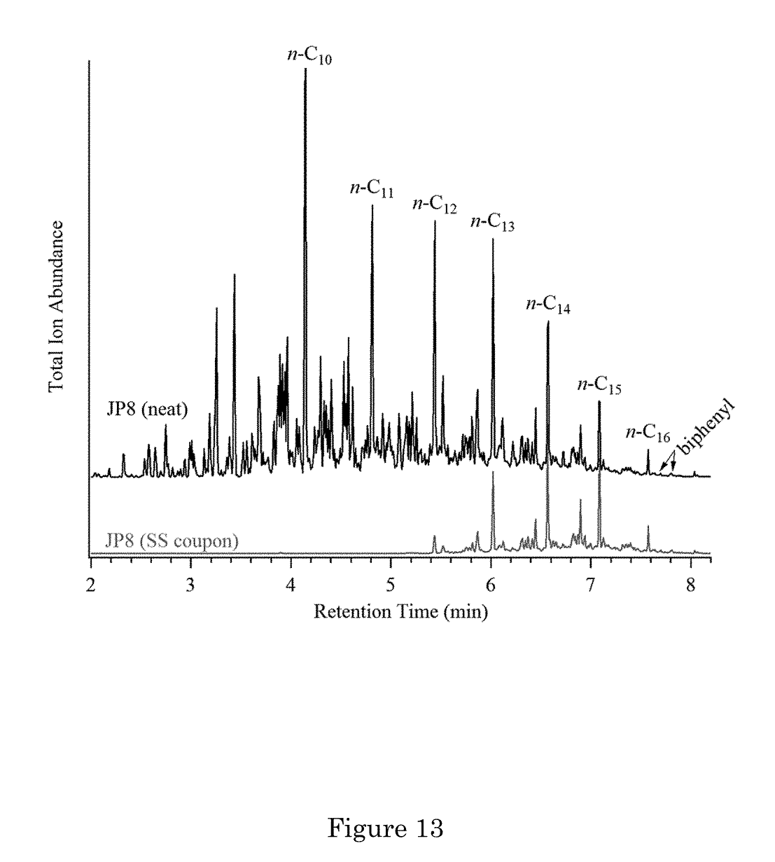

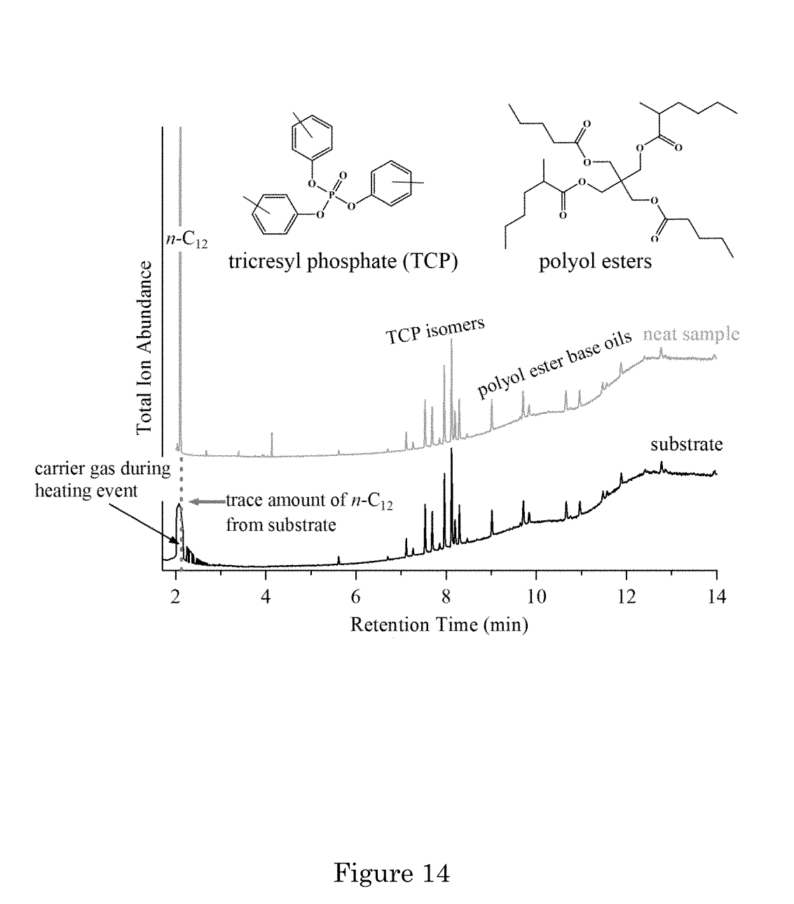

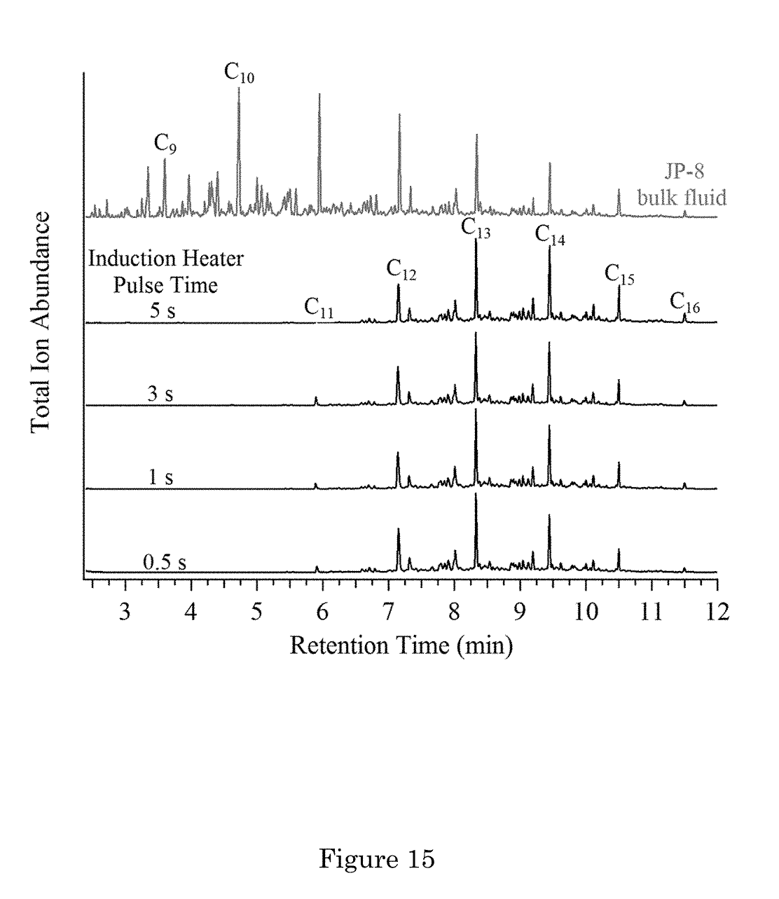

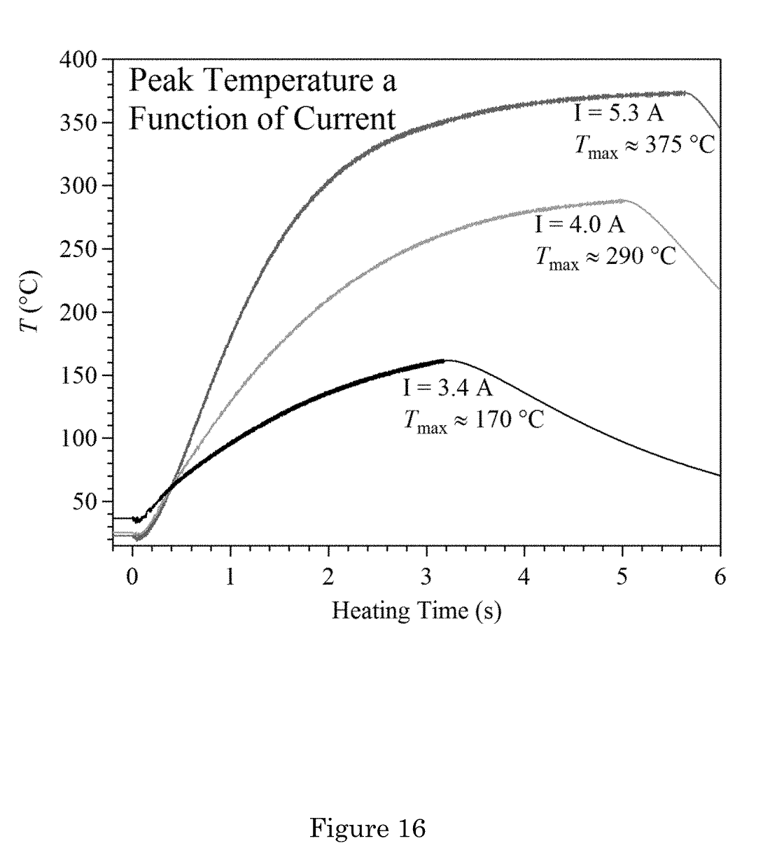

Results for JP-8 jet fuel adsorbed as surface-active species on a stainless steel coupon are shown in FIG. 13. Similarly, results for the lubricant absorbed as surface active species on the stainless steel coupon are shown in FIG. 14. FIG. 15 shows results for different pulse times for inductively heating the coupon. FIG. 16 shows inductive heating profiles for the coupon as a function of electrical current through the induction coil.

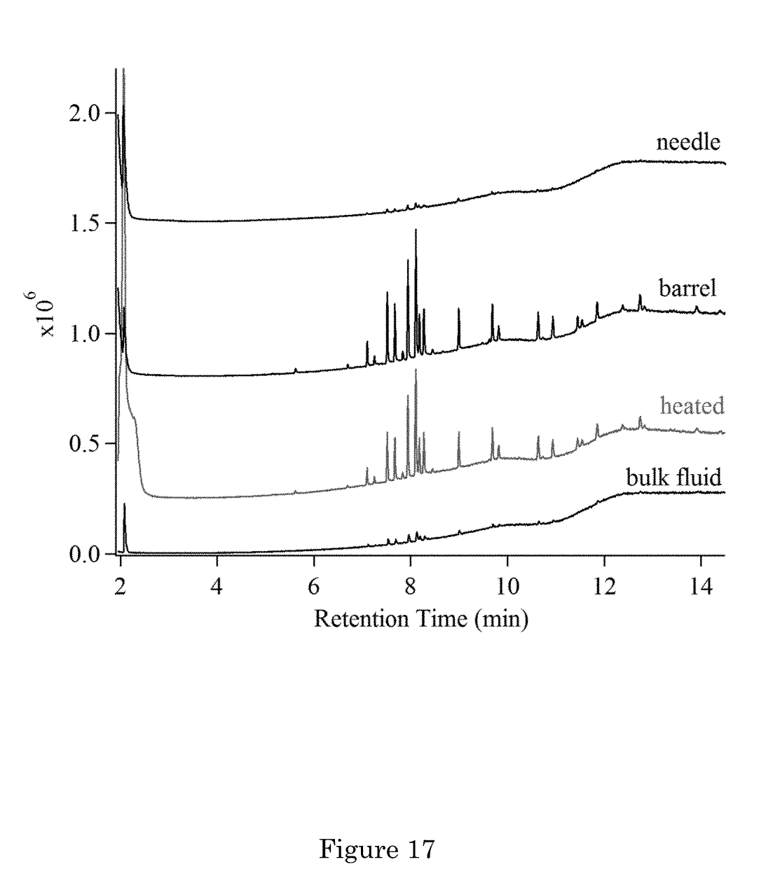

In view of the data, the amount of desorbed analyte detected increased when the temperature that the coupon and the solution the coupon was immersed in was increased. Surface-active species that had an affinity for metal or metal oxide surfaces were present in a higher concentration on the coupon than in the solution after being exposed at elevated temperature and pressure as shown in FIG. 17.

Embodiments of the subject matter and the operations described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions, encoded on a computer storage medium for execution by, or to control the operation of, data processing apparatus. Alternatively, or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described in this specification can be implemented as operations performed by a data processing apparatus on data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more computers executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application-specific integrated circuit).

Computers suitable for the execution of a computer program include, by way of example, can be based on general or special purpose microprocessors or both, workstations, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, e.g., magnetic; magneto-optical disks, optical disks, USB drives, and so on. However, a computer need not have such devices. Moreover, a computer can be embedded in another device, e.g., a mobile telephone, a personal digital assistant (PDA), a microwave oven, mobile audio or video player, a game console, a Global Positioning System (GPS) receiver, or a portable storage device (e.g., a universal serial bus (USB) flash drive), to name just a few. Devices suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The central processing unit and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks). Such interconnects may involve electrical cabling, fiber optics, or be wireless connections.

The computing system can include clients and servers. A client and server are generally remote from each other and typically interact through a communication network. The relationship of client and server arises by virtue of computer programs running on the respective computers and having a client-server relationship to each other. In some embodiments, a server transmits data (e.g., an HTML page) to a client device (e.g., for purposes of displaying data to and receiving user input from a user interacting with the client device). Data generated at the client device (e.g., a result of the user interaction) can be received from the client device at the server.

While this specification contains many specific implementation details, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

While one or more embodiments have been shown and described, modifications and substitutions may be made thereto without departing from the spirit and scope of the invention. Accordingly, it is to be understood that the present invention has been described by way of illustrations and not limitation. Embodiments herein can be used independently or can be combined.

Reference throughout this specification to “one embodiment,” “particular embodiment,” “certain embodiment,” “an embodiment,” or the like means that a particular feature, structure, or characteristic described in connection with the embodiment is included in at least one embodiment. Thus, appearances of these phrases (e.g., “in one embodiment” or “in an embodiment”) throughout this specification are not necessarily all referring to the same embodiment, but may. Furthermore, particular features, structures, or characteristics may be combined in any suitable manner, as would be apparent to one of ordinary skill in the art from this disclosure, in one or more embodiments.

All ranges disclosed herein are inclusive of the endpoints, and the endpoints are independently combinable with each other. The ranges are continuous and thus contain every value and subset thereof in the range. Unless otherwise stated or contextually inapplicable, all percentages, when expressing a quantity, are weight percentages. The suffix “(s)” as used herein is intended to include both the singular and the plural of the term that it modifies, thereby including at least one of that term (e.g., the colorant(s) includes at least one colorants). “Optional” or “optionally” means that the subsequently described event or circumstance can or cannot occur, and that the description includes instances where the event occurs and instances where it does not. As used herein, “combination” is inclusive of blends, mixtures, alloys, reaction products, and the like.

As used herein, “a combination thereof” refers to a combination comprising at least one of the named constituents, components, compounds, or elements, optionally together with one or more of the same class of constituents, components, compounds, or elements.

All references are incorporated herein by reference.

The use of the terms “a” and “an” and “the” and similar referents in the context of describing the invention (especially in the context of the following claims) are to be construed to cover both the singular and the plural, unless otherwise indicated herein or clearly contradicted by context. “Or” means “and/or.” Further, the conjunction “or” is used to link objects of a list or alternatives and is not disjunctive; rather the elements can be used separately or can be combined together under appropriate circumstances. It should further be noted that the terms “first,” “second,” “primary,” “secondary,” and the like herein do not denote any order, quantity, or importance, but rather are used to distinguish one element from another. The modifier “about” used in connection with a quantity is inclusive of the stated value and has the meaning dictated by the context (e.g., it includes the degree of error associated with measurement of the particular quantity).

What is claimed is:

1. An inductive flash desorber comprising:
an induction coil that produces a magnetic field in response to flowing an electrical current through the induction coil, the induction coil comprising an electrical conductor that is wound into a coil;
a substrate disposed through a central portion of the induction coil, the substrate comprising an electrical conductor and that:
adsorbs a surface-active species;
produces an eddy current in presence of the magnetic field;
heats in response to producing the eddy current; and
desorbs the surface-active species in response to being heated to form desorbed analyte from the surface; and
a flow tube interposed between the induction coil and the substrate such that the flow tube:
is encircled by the coil;
surrounds the substrate within the coil;
receives a carrier fluid that entrains the desorbed analyte from the substrate; and
forms an analytical composition comprising the carrier fluid and the desorbed analyte, the flow tube comprising:
a first end that receives the carrier fluid; and
a second end opposing the first end and through which the analytical composition flows.

2. The process of claim 1, wherein the substrate comprises a metal wire.

3. The process of claim 1, wherein the flow tube comprises a syringe.

4. A process for performing inductive desorption, the process comprising:
adsorbing a surface-active species on a substrate of an inductive flash desorber that comprises:
an induction coil comprising an electrical conductor that is wound into a coil;
a substrate disposed through a central portion of the induction coil and comprising an electrical conductor; and
a flow tube interposed between the induction coil and the substrate such that the flow tube is encircled by the coil and surrounds the substrate within the induction coil, the flow tube comprising:
a first end; and
a second end opposing the first end;
flowing an electrical current through the induction coil;
producing, by the induction coil, a magnetic field in response to flowing the electrical current;
producing, by the substrate, an eddy current in presence of the magnetic field;
heating the substrate in response to producing the eddy current;
desorbing the surface-active species from the substrate in response to being heated to form a desorbed analyte from the surface-active species;
flowing a carrier fluid through the flow tube from the first end towards the second end;
entraining the desorbed analyte in the carrier fluid in the flow tube to form an analytical composition comprising the carrier fluid and the desorbed analyte; and
flowing the analytical composition toward the second end and away from the first end to perform inductive desorption.

5. The process of claim 4, further comprising:
communicating the analytical composition to a chemical analyzer from the second end; and
determining a chemical identity of the desorbed analyte.

6. The process of claim 4, wherein heating the substrate comprises heating to 700° C. from room temperature in less than 2 seconds.

7. The process of claim 4, wherein heating the substrate consists essentially of inductive heating in an absence of contact heating.

8. The process of claim 4, wherein the surface-active species is present in an amount from 1 part per trillion to 100 parts per thousand.

9. The process of claim 4, wherein desorbing the surface-active species from the substrate occurs in an absence of a liquid solvent in the flow tube.

10. The process of claim 4, wherein the desorbed analyte is identical to the surface-active species.

11. The process of claim 4, wherein the desorbed analyte is different than the surface-active species.

12. The process of claim 4, wherein the electrical current is alternating current.

13. The process of claim 4, wherein the flowing the carrier fluid flows in the flow tube consists essentially of laminar flow.

14. The process of claim 4, wherein flowing the carrier fluid in the flow tube comprises flowing the carrier fluid from a first end of the flow tube to a second end of the flow tube.

15. The process of claim 4, wherein the flow tube comprises a syringe.

16. The process of claim 4, wherein the substrate comprises a wire.
